(19) United States
(12) Patent Application Publication
(10) Pub. No.: US 2015/0142363 A1
(43) Pub. Date: May 21, 2015

(54) Model-based noise suppression for level indicators

(71) Applicant: VEGA Grieshaber KG, Wolfach (DE)

(72) Inventor: Christian HOFERER, Offenburg (DE)

(21) Appl. No.: 14/528,370

(22) Filed: Oct. 30, 2014

(30) Foreign Application Priority Data
Nov. 4, 2013 (EP) 13 191 426.9

(51) Int. Cl. G01F 25/00; G01F 23/00

(52) U.S. Cl. CPC G01F 25/0061; G01F 23/00
USPC 702/100

(57) ABSTRACT

A model is based on noise-suppression technique in level indicators that uses mutually independent mathematical models, the quality of each of which models is calculated by comparing with measured values. The models are then weighted and combined, or a single model is selected, in order to calculate the level at a later point in time. Effective noise suppression may be achieved by these means.

### REFERENCE TO RELATED APPLICATION

This application claims the benefit of the filing date of European Patent Application Serial No. 13 191 426.9 filed on 4 Nov. 2013, the disclosure of which is hereby incorporated herein by reference.

### FIELD OF THE INVENTION

The invention relates to level measurement. In particular, the invention relates to a level indicator, a method for determining a level of a bulk material, a program element and a machine-readable medium.

### BACKGROUND

In order to suppress the noise in measured values from time-sequential measurements, averaging techniques are often used. This means that an average of a plurality of time-sequential measured values is found. The number of measured values for which the average shall be found can be chosen to suit, and must be set manually by the customer or by service personnel according to the application. For slow-changing measurements, i.e. the bulk-material surface is moving only slowly, the averaging is allowed to comprise a large number of measured values, whereas for fast measurements only a few. This is because otherwise the averaging could result in an offset or large mismatch arising between the levels that are output and the position of the bulk-material surface.

In particular when switching between filling and emptying a tank, this time lag or inertia of the sensor may be observed when using a conventional averaging technique according to the current prior art. As result of the averaging, the sensor may have a delayed response at its output to the changes in the level. In the worst case, this situation may lead to overfilling of the container or to dry-running of a pump.

### SUMMARY OF THE INVENTION

According to a first aspect of the invention, a level indicator for determining a level of a bulk material is defined that comprises a sensor device and a control unit. The sensor device is used for capturing a measured value that corresponds to the level of the bulk material at a first point in time. Level indicators comprising such sensor devices are known. These level indicators are, for example, radar level indicators or ultrasound devices, which emit a measurement signal from an antenna towards the bulk-material surface, and analyse the received signal reflected at the bulk-material surface (and possibly at other reflectors such as container floors, partitions or parts fitted in containers). The level of the bulk material at the time of the measurement can then be determined from this received signal.

A plurality of measured values from a measurement can also be used to calculate the level. It may always be the case, however, that precisely one of the measured values corresponds to the level even if a plurality of measured values are used from the measurement curve to actually determine the level.

The control unit is designed to perform the following steps for the captured measured value: first, different and mutually independent mathematical models are updated using the captured measured value. This “updating” can mean that the captured measured value is fed into each one of the mathematical models, and each one of the models then calculate from this measured value a predicted, future level. FIG. 5 contains a sketch of this updating for models that work in combination with Kalman filters.

The control unit then calculates the quality of each individual model. In particular, a measured value captured by the sensor device at a second point in time, which is after the first point in time, which measured value corresponds to the level of the bulk material at the second point in time, can be used for this purpose. For example, the quality calculation can take into account how well each model has predicted the (measured) level, which has been determined at the later point in time by measurement.

Then the control unit can weight and combine the models or select one of the models, according to the respective quality of the model, whereupon it can use the weighted and combined models or the selected model to calculate the level of the bulk material at the second, later point in time. It can then output the calculated level.

In other words, the control unit may first use a plurality of different and mutually independent mathematical models employing the measured value captured at the first point in time to calculate possible levels of the bulk material at the second point in time. Then the indicator can capture a level of the bulk material at the second point in time. This level at the second point in time can then be used for weighting and combining the models or for selecting one of the models by using the level to calculate the quality of each of the individual models.

The quality of each individual model can be calculated, for example, by comparing the level at the second point in time with the level at this second point in time calculated by the model.

The level of the bulk material is then output at the second point in time, although this level is not a measured level but the level calculated by the weighted and combined models or solely by the selected model.

Thus the first aspect of the invention relates to a level indicator which uses different mathematical models to predict a future, expected measured value for the level.

The mathematical models are updated using existing measured values. This shall be understood to mean that they (each individually or as a combined model) predict (forecast) a future level that is meant to occur at a specified point in time, which prediction involves the existing measured value being imported (fed) into each of the mathematical models (or the combined model), and the new, probable value at the specified point in time being calculated from this measured value. Once this point in time has actually arrived, the level is actually measured by the device, and the measurement result used to calculate the quality of each individual model. The quality of a model is a measure of its ability to predict the level correctly. The greater the disparity between the level predicted by the particular model and the actually measured level, the worse the quality becomes.

On the basis of the quality calculation, the individual models are then weighted and combined into a combined model, or the best model is selected, which model(s) is/are then used to calculate further future levels.

In other words, the combined model used and/or each individual model is separately examined by comparison with a currently measured value of the level, whereupon the combined model can be adapted in order to improve further the prediction of the level in future.

According to the invention, first the level is measured and the measurement result is used by each of the mathematical models (or by a combined model consisting of selected weighted and combined models) to calculate a predicted future level. The (mathematical) models are used to predict the future, i.e. a level expected in the future. This prediction is improved by comparing the prediction result with the actual measured value captured at this later point in time, followed by an appropriate selection or combination of the individual models. It is thereby possible to predict with high accuracy the level expected in the future.

Specific terms used in the application are defined below.

### Situation (Filling/Emptying/Stationary):

Situations arising at a measurement location are, for example, certain circumstances that may arise during a measurement such as, for example, the filling of the tank/container, the emptying of the tank or a constant level, in which situation the bulk-material surface does not move. The “situation” that exists at a particular moment in time hence concerns the visible events as would be perceived by a person.

### Model/System Model:

If it is required to describe mathematically just this purely human perception of the situations in order to filter out noise, if applicable, to make predictions or simply to model the situations mathematically, then an appropriate model is necessary. This model incorporates the physical properties of a level measurement.

The suitability of particular mathematical models to describe different situations differs. The invention therefore makes use of a plurality of models at the same time. The individual model can be expressed, for example, using differential equations. Time-discretization, which is usually the case in level measurement, then produces a time-discrete model.

### State:

The “state” in the narrower sense is the quantity being sought, for example the level of the bulk material. In the broader context, it includes the current calculation progress of the model. In simple terms, how does the model look exactly overall (i.e. the matrices and vectors that specify the model) at a time k?

If the (time-discrete) model is known, then a state estimator (for example a Kalman filter) can be used to determine the state of the system model/model. The term state can be understood to mean the totality of all the values/variables of the model and estimator at a fixed time k.

In addition, the vector \hat{x}ₖ can be referred to as a state vector. This state vector can contain the position \hat{p}ₖ of the bulk-material surface that is being sought. Furthermore, it can also contain the estimate of the velocity \hat{v}ₖ at which the position of the bulk-material surface is changing. Thus “level” can only be equated to “state” in certain cases.

The level indicator is intended to improve the accuracy of the bulk-material surface determination by this means. The actual measured value usually contains noise, i.e. even for a stationary surface it cannot be assumed that two successive measurements return an identical measured value and hence return the same level. This imprecision is due to the noise that is inherent in the measurement because of the system. The causes of this noise may be the components used, the design of the indicator itself, thermal noise, external interference or inherent system noise, which often exists in technical equipment. This unwanted noise affects the measurement precision.

According to an embodiment of the invention, the control unit is designed to specify each of the mathematical models using Kalman filters.

According to a further embodiment of the invention, the control unit is designed to specify possible states of the bulk material at a third point in time, which is later than the second point in time, by means of the plurality of different and mutually independent mathematical models using the calculated level at the second point in time.

According to a further embodiment of the invention, the models take into account the geometries of the container holding the bulk material.

According to a further embodiment of the invention, the control unit is designed to calculate the quality of each individual model, and to weight and combine the models or to select one of the models, with due regard to a difference between the bulk-material level measured by the level indicator at the second point in time and the levels calculated by the updated models.

In particular it can be provided that the bulk-material level calculated by the weighted and combined models or by the selected model at the second point in time is used to update the independent mathematical models

This enables in particular those models that do not fit the current situation, and hence return an incorrect prediction of the level, to continue to track the position of the bulk-material surface. According to a further aspect of the invention, a method for determining a level of a bulk material is defined, in which method first a measured value is captured that corresponds to the level of the bulk material at a first point in time. Then different and mutually independent mathematical models are updated using the captured measured value. Next, the quality of each individual model is calculated, and the models are weighted and combined or one of the models is selected, in each case according to the respective quality of the model. Then a level of the bulk material at a second, later point in time is calculated by the weighted and combined models or by the selected model, and the level calculated by the weighted and combined models or by the selected model is output.

According to a further aspect of the invention, a program element is defined that, when executed on a control unit of a level indicator, instructs the control unit to perform the steps described above and below.

In this case, the program element can be part of a piece of software, for example, that is stored on the processor of a level indicator. The processor here can likewise be the subject matter of the invention. In addition, this embodiment comprises a program element which right from the start uses the invention, and also comprises a program element that by an update causes an existing program to use the invention.

According to a further aspect of the invention, a machine-readable medium is defined on which a corresponding program element is stored.

Embodiments of the invention are described below with reference to the figures.

### SHORT DESCRIPTION OF THE FIGURES

FIG. 1 shows a level indicator according to an embodiment of the invention.

FIG. 2 is a flow diagram of a method according to an embodiment of the invention.

FIG. 3 is a flow diagram of a method according to a further embodiment of the invention.

FIG. 4 is a flow diagram of a method according to a further embodiment of the invention.

FIG. 5 shows an extract from a document by Welch and Bishop that is referred to below.

### DETAILED DESCRIPTION OF EMBODIMENTS

The depictions in the figures are schematic and not to scale.

Where the same reference numerals are used in different figures in the following description of the figures, they denote the same or similar elements. The same or similar elements may also be denoted by different reference numerals, however.

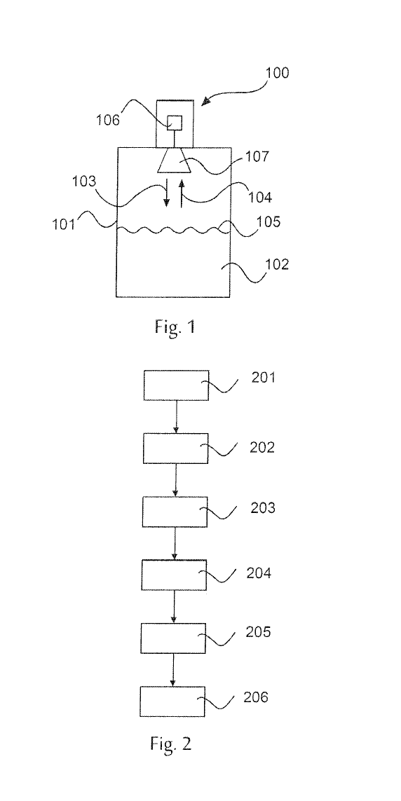

FIG. 1 shows a level indicator according to an embodiment of the invention. The level indicator 100 is, for example a radar level indicator or another type of indicator that can determine the position of a bulk-material surface 105 of a bulk material 102 held in the container 101. The indicator 100 comprises a sensor device 107, for example in the form of a transmit/receive antenna. The transmit/receive antenna 107 emits a measurement signal 103 towards the bulk-material surface 105. The measurement signal is then reflected at least in part at the surface of the bulk material 105 back towards the transmit/receive antenna 107 (cf. arrow 104).

The transmit/receive antenna then detects the reflected measurement signal and transfers it to the electronics 106 of the level indicator 100. The electronics 106 comprises a control unit, and for the sake of simplicity is referred to below in its entirety as the “control unit”.

In order to suppress the noise, the level indicator is able to find the average of the measured values that the level indicator has received in time-sequential measurements. In this process, however, the aim is to reduce the offset or mismatch between the actual position of the bulk-material surface and the measured value that was last output, or more specifically the level that was output.

To do this, the control unit uses the knowledge of the basic circumstances that exist for level indicators.

For example, if the level of the medium in a container is to be captured, the following situations can arise:
The container is emptied at constant speed.
The container is filled at constant speed.
The position of the bulk-material surface changes with a constant acceleration during emptying.
The position of the bulk-material surface changes with a constant acceleration during filling.
The container is not being filled or emptied, i.e. the level is not changing.

The possible situations that may arise in the tank can now be described using a mathematical model. Time-discrete models in particular are suitable for this, which advantageously can be used in microcontrollers to model systems, and are adapted such that the state of the model can be determined using an appropriate state estimator (e.g. a Kalman filter).

Kalman filters estimate the state of a technical system. In addition to this pure state-estimation, an estimate of the certainty of the state estimate is also made (self-evaluation). In this context, reference should be made to the document by Greg Welch und Gary Bishop entitled “An Introduction to the Kalman-Filter” dated 24 Jul. 2006. In the wider context, a Kalman filter represents the combination of mathematical model of a technical system and state estimator itself. The Kalman filter hence contains a mathematical model for describing, for example, the above-mentioned situation, and a mechanism for estimating the state of the model. In addition, an estimated prediction can be made as to how the state of the system will change in a next step.

A single Kalman filter that estimates the measured value or level normally cannot model all the above-mentioned situations in the container with sufficient accuracy. If, however, a plurality of individual Kalman filters are used, each of which describes a situation, then these filters can be combined with one another according to the quality they currently have (“how well does the relevant model fit the current measurement result?”).

Hence the accuracy of the determined level can be improved by, in a first step, using different, mutually independent mathematical models to describe by means of Kalman filters the situations (filling/emptying/stationary) that may arise during the measurement, and in a further step, according to the situation that currently exists (filling/emptying/stationary), combining in a weighted manner the different Kalman filters or switching on one of said Kalman filters so that for the situation that currently exists (filling/emptying/stationary), the Kalman filter given the largest weighting is always the Kalman filter that best fits the current situation with its underlying system model.

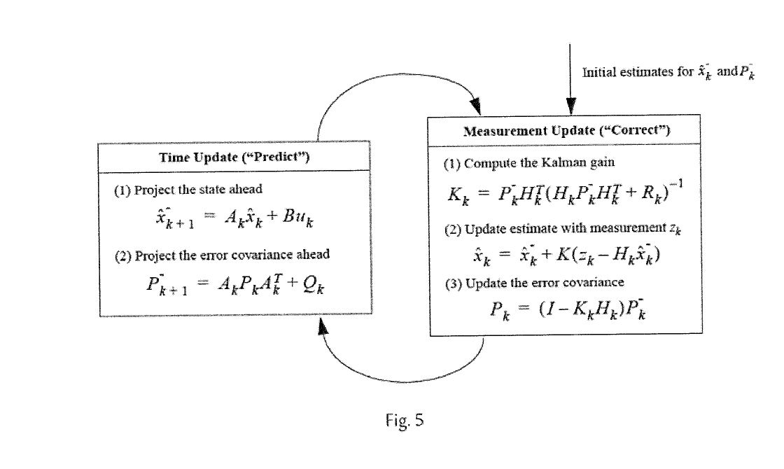

The equations defined in the document by Welch and Bishop can be represented in combination as depicted in FIG. 5.

For the technical implementation of the described method, it is first necessary to have the different mathematical models that describe the possible situations in the container. For better understanding, it is assumed that the level changes linearly in the container or remains at a specific position.

Hence two different models are needed for this: one model which models the situation of a moving level, and one model which reflects the situation of a stationary bulk-material surface. Examples of suitable mathematical models that can be used by the control unit to calculate the level are given below.

Proceeding from the document by Welch and Bishop, the following models can be developed.

1. Example model representing a moving bulk-material surface:

$${\hat{x}}_{k} = [ \begin{matrix}{\hat{p}}_{k} \\ {\hat{v}}_{k}\end{matrix} ]$$

$$A = [ \begin{matrix}1 & Δ t \\ 0 & 1\end{matrix} ]$$

k: index (step/measurement k)
\hat{p}ₖ: calculated position of the bulk-material surface at time k
\hat{v}ₖ: calculated velocity of the bulk-material surface at time k
A: transition matrix, which specifies how the state of the system at time k−1 shall be projected onto the state k
Δt: time between the measurements k und k−1

$${z}_{k} = [ \begin{matrix}{\tilde{p}}_{k} \\ 0\end{matrix} ]$$

$$H = [ \begin{matrix}1 & 0 \\ 0 & 0\end{matrix} ]$$

zₖ: vector that combines all the measured quantities
\tilde{p}ₖ: measurement of the position of the bulk-material surface at time k
H: matrix giving the relationship between measurement zₖ and system state xₖ (zₖ=H*xₖ)

$$Q = [ \begin{matrix}0.001 & 0 \\ 0 & 1\end{matrix} ]$$

$$R = [ \begin{matrix}1 & 0 \\ 0 & 1\end{matrix} ]$$

Q: example of how the system noise can be modelled
R: example of how the measurement noise can be modelled
2. Model representing a stationary bulk-material surface:
\hat{x}ₖ=[\hat{p}ₖ] A=[1]
zₖ=[\tilde{p}ₖ] H=[1]

### Q=[0.00001] R=[1]

In both examples it is assumed that the matrices for modelling the system are constant. The index k is therefore dispensed with in the example.

The quality with which each model estimates the level differs in different situations. They should be viewed only as an example, however. In particular, the absolute numerical values in the matrices Q and R are parameters that can be used to adapt the filter concerned optimally to the current situation. Again in this case there is the option to have multiple implementations of the individual models using different filter properties and to combine or fix on individual models in the subsequent step.

All the individual models from the above example can then be selectively combined in a second step. FIG. 3 shows a structure for this.

It is evident that each model, which describes a situation (filling/emptying/stationary), is supplied with information about the current measured value \tilde{p}ₖ 301. Inside the function blocks 302, 303, 304, 305, which are labelled model 1 to model N, a measured value captured by the level indicator is used to update the system model, as depicted higher up in the diagram. The measured value itself in this example is just the position of the bulk-material surface. For a sensor that in addition to the pure distance value also measures the velocity at which the bulk-material surface is moving (e.g. for radar sensors that evaluate the Doppler shift), this additional measured value can also be used for updating the models.

The estimated levels, or rather the estimated measured values, output by the N models (N is an integer), in step 306 are then weighted and combined or the currently valid model (the model that returns the best estimate result) is selected. In step 307, the level or measured value p̅ₖ calculated by the model(s) is then output.

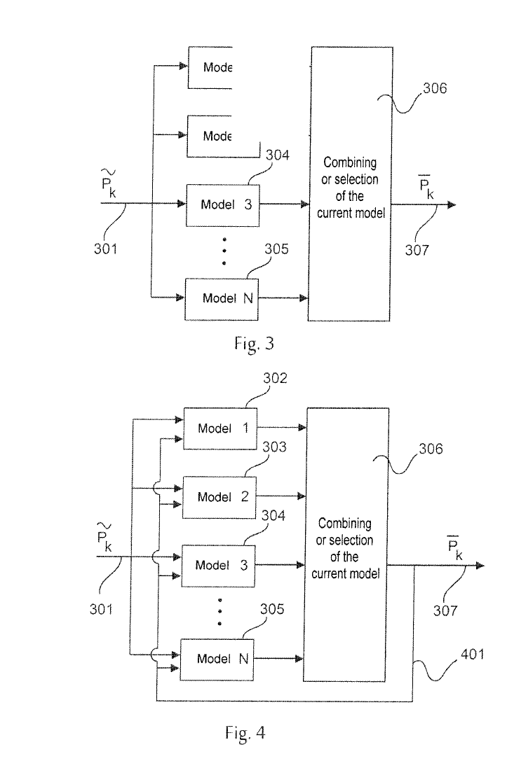

FIG. 4 shows an advantageous embodiment in which the individual models can be updated. Based on FIG. 3, in this case the calculated value 307 is additionally fed back 401 to the original N models 302 to 305. This enables in particular the models that do not fit the current situation to continue to track the position of the bulk-material surface. This ensures the stability of the individual models. This means that the estimate of the position of the bulk-material surface by the individual models does not diverge from the actual position of the bulk-material surface, because the individual models can be brought to a suitable “initial position” by the updating, which also uses the calculated value 307.

The function block 306 can be labelled as “Combining or selection of the current model”, and combines the individual states of the different models or selects a single model and outputs the measured value therefrom at the output of the control unit.

The selection of the correct model or the weighting factor to be used on the respective model is obtained, for example, from the difference between the prediction given by the model (i.e. the level calculated by the relevant model at a certain point in time) and the level at this point in time that the level indicator has determined by measurement.

For the second model, which describes a stationary bulk-material surface, the prediction of the level for a further measurement equals the estimate of the level for the previous measurement, because the model assumes that the bulk-material surface has not moved.

The first model assumes that the bulk-material surface is moving at the velocity \hat{v}ₖ, and hence expects the new measured value from the sensor to be at the position that is obtained from the old position of the bulk-material surface and the distance covered between two measurements (distance=\hat{v}ₖ*Δt).

In a simple method, the model that can be deemed currently the best is the model for which the prediction is closest to the current measured value \tilde{p}ₖ.

In a simple method for combining a plurality of models, a weighting factor is calculated according to the difference between prediction and measured value \tilde{p}ₖ. In this example, this weighting factor corresponds to the quality of the model. The quality hence indicates the suitability of the respective model to represent the measured value. In other words, the quality is a measure of how well the model describes the current situation. The algorithm for determining the quality should be regarded here merely as an example. Other methods are possible. Two models (model A, model B) are given by way of example. Say the current measured value is \tilde{p}ₖ=100 mm. Model A estimates the measured value to be \hat{p}_{model A,k}=101 mm, model B estimates the measured value to be \hat{p}_{model B,k}=105 mm. An algorithm for the quality might have the following form for the example.

$$\begin{matrix}Quality for A = 1 - ( \vert {\hat{p}}_{model A , k} - {\tilde{p}}_{k} \vert ) / ( \begin{matrix}( \vert {\hat{p}}_{model A , k} - {\tilde{p}}_{k} \vert ) + \\ ( \vert {\hat{p}}_{model B , k} - {\tilde{p}}_{k} \vert )\end{matrix} ) \\ = 1 - ( \vert 101 mm - 100 mm \vert ) / ( \begin{matrix}( \vert 101 mm - 100 mm \vert ) + \\ ( \vert 105 mm - 100 mm \vert )\end{matrix} ) \\ = 1 - 1 / ( 1 + 5 ) \\ = 5 / 6\end{matrix}$$

$$\begin{matrix}Quality for B = 1 - ( \vert {\hat{p}}_{model B , k} - {\tilde{p}}_{k} \vert ) / ( \begin{matrix}( \vert {\hat{p}}_{model A , k} - {\tilde{p}}_{k} \vert ) + \\ ( \vert {\hat{p}}_{model B , k} - {\tilde{p}}_{k} \vert )\end{matrix} ) \\ = 1 - ( \vert 105 mm - 100 mm \vert ) / ( \begin{matrix}( \vert 101 mm - 100 mm \vert ) + \\ ( \vert 105 mm - 100 mm \vert )\end{matrix} ) \\ = 1 - 5 / ( 1 + 5 ) \\ = 1 / 6\end{matrix}$$

The combined measured value p̅ₖ might then be composed as follows: p̅ₖ=Quality for A*\hat{p}_{model A,k}+Quality for B*\hat{p}_{model B,k}

Of course if \hat{p}_{model A,k}=\hat{p}_{model B,k}=\tilde{p}ₖ then combining is not necessary and, in the example, not possible arithmetically.

A more complex method for combining the individual models is known as the “interacting multiple model (IMM)”. This is an advantageous way of combining the different models. In the IMM, a likelihood function is used likewise to calculate a quality of the individual models.

FIG. 2 is a flow diagram of a method according to an embodiment of the invention. In step 201, the level indicator captures a measured value, which corresponds to the position of the bulk-material surface, for example. This measured value is then passed to the different mathematical models and calculations are performed thereon. Each of the models conducts a state estimation which involves each of the models being updated. If the models use Kalman filters, the Kalman filters are updated (step 202).

In step 203, the quality of each of the models is calculated, for example by using for this calculation a new measured value captured at a later point in time, which measured value corresponds to the level of the bulk material at the later point in time. It should be pointed out in this connection that “measured value that corresponds to a level” can be equated to “level” in the application.

In addition to the new measured value, other quantities can also be included for the quality calculation. For example, matrices of the state estimator can be included. A comparison of the new measured value with the states of the model (i.e. the level calculated by each model) is the simplest example. The quality is a value that expresses how well the mathematical model determines the current situation (filling/emptying/stationary) and the position of the bulk material.

In step 204, the models are then combined or selected according to the quality thereof. In step 205, the level is then calculated from the resultant combined model or the selected model that has the highest quality, and in step 206, this level is output by means of HART, for example, or displayed.

It should be mentioned hereinafter that the terms “comprising” and “having” do not exclude any other elements or steps, and “a” or “an” does not rule out more than one. It should also be pointed out that features or steps that have been described with reference to one of the above embodiments can also be used in combination with other features or steps of other embodiments described above. Reference numerals in the claims shall not be deemed to have a limiting effect.

1. A level indicator for determining a level of a bulk material, comprising:
a sensor device capturing a measured value that corresponds to the level of the bulk material at a first point in time; and
a control unit performing following steps for the captured measured value:
updating different and mutually independent mathematical models using the captured measured value;
calculating a quality of each individual model;
weighting and combining the models or selecting one of the models according to the respective quality of the model;
calculating a level of the bulk material at a second, later point in time by the weighted and combined models or by the selected model; and
outputting the level calculated by the weighted and combined models or by the selected model.

2. The level indicator according to claim 1, wherein the control unit is designed to specify each of the mathematical models using at least one Kalman filter.

3. The level indicator according to claim 1, wherein the control unit is designed to specify possible states of the bulk material at a third point in time, which is later than the second point in time, by means of the plurality of different and mutually independent mathematical models using the calculated level at the second point in time.

4. The level indicator according to claim 1, wherein the models take into account a geometry of the container holding the bulk material.

5. The level indicator according to claim 1, wherein the control unit is designed to calculate the quality of each individual model, or to weight and combine the models or to select one of the models, with due regard to a difference between the bulk-material level measured by the level indicator at the second point in time and the levels calculated by the updated models.

6. A method for determining a level of a bulk material, comprising the steps:
capturing a measured value that corresponds to the level of the bulk material at a first point in time;
updating different and mutually independent mathematical models using the captured measured value;
calculating a quality of each individual model;
weighting and combining the models or selecting one of the models according to the respective quality of the model;
calculating a level of the bulk material at a second, later point in time by the weighted and combined models or by the selected model; and
outputting the level calculated by the weighted and combined models or by the selected model.

7. A program element, which, when executed on a control unit of a level indicator, instructs the control unit to perform the following steps:
updating different and mutually independent mathematical models using the captured measured value;
calculating a quality of each individual model;
weighting and combining the models or selecting one of the models according to the respective quality of the model;
calculating a level of the bulk material at a second, later point in time by the weighted and combined models or by the selected model; and
outputting the level calculated by the weighted and combined models or by the selected model.

8. A machine-readable medium on which is stored a program element according to claim 7.
